(19) United States
(12) Patent Application Publication
(10) Pub. No.: US 2018/0241476 A1
(43) Pub. Date: Aug. 23, 2018

(54) Polarization analyzer based detection schemes for pol-mux self-coherent single sideband optical transmission

(71) Applicant: Arizona Board of Regents on Behalf of the University of Arizona, Tucson, AZ (US)

(72) Inventors: Stanley Johnson, Tucson, AZ (US); Milorad Cvijetic, Tucson, AZ (US)

(21) Appl. No.: 15/759,899

(22) PCT Filed: Sep. 15, 2016
(86) PCT No.: PCT/US16/51839

§ 371 Date: Mar. 14, 2018

Related U.S. Application Data
(60) Provisional application No. 62/218,845, filed on Sep. 15, 2015.

(51) Int. Cl. H04B 10/61; H04J 14/06

(52) U.S. Cl. CPC H04B 10/614; H04L 5/0007; H04B 10/6151; H04J 14/06

(57) ABSTRACT

An orthogonal frequency division multiplexing (OFDM) transmitter is able to communicate simultaneously with a simple direct detection receiver and also with a coherent receiver. The transmitter transmits a polarization multiplexed self-coherent signal by multiplexing a carrier in the polarization state orthogonal to the polarization state of the data signal that is embodied in the sidebands. In accordance with one particular aspect of the disclosure, the direct detection receiver receiving this self-coherent signal utilizes a single polarization analyzer before the photodiode, which simplifies the receiver architecture for direct detection of a polarization multiplexed self-coherent single sideband signal.

### CROSS-REFERENCE TO RELATED APPLICATION

This application claims the benefit of U.S. Provisional Application Ser. No. 62/218,845, filed Sep. 15, 2015, the disclosure of which is incorporated herein by reference.

### GOVERNMENT FUNDING

This invention was made with government support under Grant No. EEC0812072, awarded by NSF. The government has certain rights in the invention.

### BACKGROUND

Orthogonal frequency division multiplexing (OFDM) is a special case of multi-carrier modulation based on the discrete Fourier transform in which a high bit rate stream is separated into a large number of low data rate sub-channels, each of which modulates a single carrier. Subcarriers are spaced by the reciprocal of the sub-channel symbol time and are thus orthogonal. Self-coherent OFDM, in which the pilot or carrier is transmitted along with the data and extracted by the receiver in the optical domain so that it may be used as the local oscillator, has been the subject of ongoing research primarily due to its potential for simplified receiver architecture. Transmitting the carrier that serves as the local oscillator (LO) at the receiver side, has been achieved using spectral, temporal or polarization multiplexing or by using a virtual carrier. Each method has its own drawbacks, such as: (i) the need for narrow bandwidth optical filtering for carrier extraction and a guard band placed between signal and carrier in both spectral multiplexing and the virtual carrier methods, (ii) reduction of the transmission capacity in temporal multiplexing, and (iii) the need for polarization tracking or polarization diversity reception in polarization multiplexing.

Experiments with spectrally overlapping polarization multiplexed OFDM streams rely on polarization diversity reception, complex digital signal processing

Experiments with spectrally overlapping polarization multiplexed OFDM streams rely on polarization diversity reception, complex digital signal processing (DSP) and periodic training symbols or on the use of narrow band optical filtering to separate the carrier, as well as the use of additional filtering to separate the undesirable OFDM stream originating from the orthogonal polarization.

### SUMMARY

In accordance one aspect of the present disclosure, an orthogonal frequency division multiplexing (OFDM) transmitter is provided that is able to communicate simultaneously with a simple direct detection receiver and also with a coherent receiver. The transmitter transmits a polarization multiplexed self-coherent signal by multiplexing a carrier in the polarization state orthogonal to the polarization state of the data signal that is embodied in the sidebands. In accordance with one particular aspect of the disclosure, the direct detection receiver receiving this self-coherent signal utilizes a single polarization analyzer before the photodiode, which simplifies the receiver architecture for direct detection of a polarization multiplexed self-coherent single sideband signal.

The performance of the single analyzer based direct detection receiver has been verified in the experimental context of the transmitter transmitting both single sideband and double sideband signals at different times. The disclosed receivers are particularly useful for the detection of single sideband signals in which the end-to-end data signal frequency range is either above or below the carrier frequency, but not equal to or overlapping with the carrier frequency. In addition, the resilience of the direct detection mode to fiber nonlinearities have been experimentally verified and receiver sensitivity improvements of up to 1.8 dB have been achieved as compared to the conventional intensity modulation and direct detection (IMDD) OFDM scheme. The ability of a dual analyzer based balanced detection scheme to achieve better performance compared to the single analyzer based detection scheme has also been verified. This scheme is also more resilient to small changes in the polarization state of the received light.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 shows a simplified block diagram of one example of an OFDM transmission system.

FIG. 2 shows a conventional intensity modulation and direct detection (IMDD) OFDM signal.

FIG. 3 shows a single-sideband (SSB) OFDM signal in which the signal and carrier are transmitted in orthogonal polarization states in accordance with the present disclosure.

FIG. 4 shows the optical processing unit of a direct detection receiver.

FIG. 5 shows a DSB OFDM signal being sent to a coherent receiver in which the two sidebands are transmitted in one polarization state and the carrier is transmitted in the orthogonal polarization state.

FIG. 6 shows the electrical or RF transmit path of a coherent OFDM transmitter that was implemented on a field-programmable gate array (FPGA).

FIG. 7 shows various subcarrier loading schemes.

FIG. 8 shows a transmission system that employs a coherent OFDM transmitter that incorporates the RF transmit path of FIG. 6.

FIG. 9 shows a receiver FPGA system used in the transmission system of FIG. 8.

FIGS. 10(a)-10(d) show the bit-error rate (BER) performance of the polarization-multiplexed SSB-OFDM scheme versus the intensity modulation and direct detection (IMDD) OFDM scheme for BPSK and QPSK modulation formats at 13 dBm and 17 dBm launch powers into the optical fiber.

FIGS. 11(a), (c) and (d) show the BER of various transmission schemes and FIG. 11(b) shows the dual analyzer balanced detection arrangement that was used.

FIGS. 12-14 show examples of unbalanced receivers that include a single photodetector.

FIGS. 15-18 show examples of balanced receivers that include a pair of photodetectors.

FIGS. 19-21 show the signal amplitudes and SNRs used to determine suitable angles for the polarization analyzer angle α.

### DETAILED DESCRIPTION

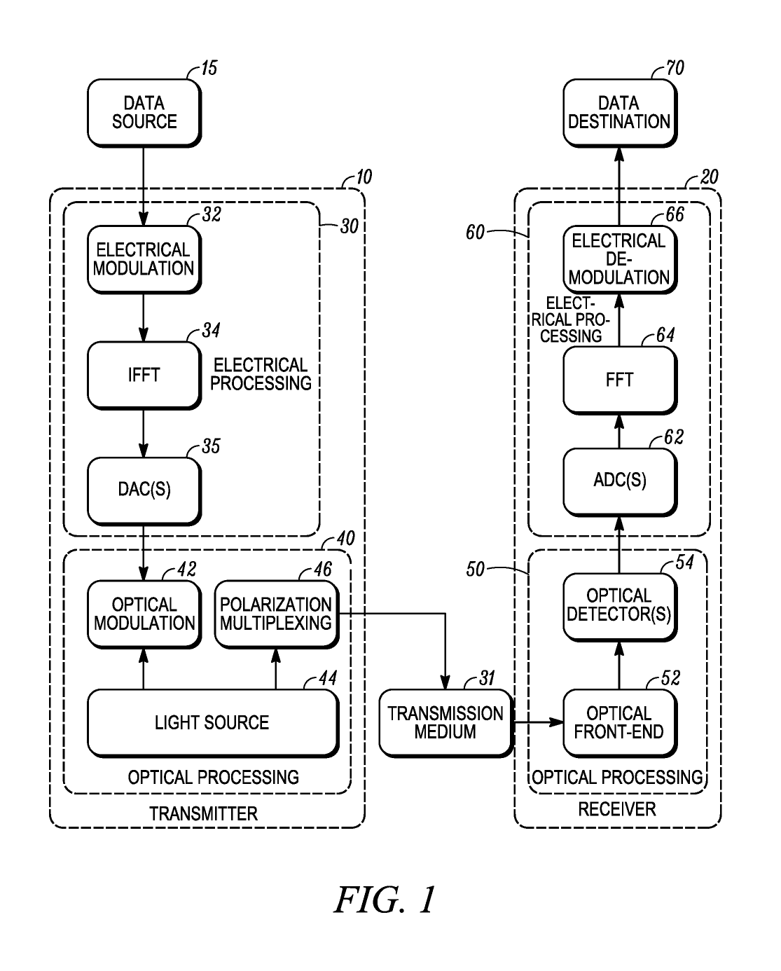

As explained in more detail below, an OFDM transmitter transmits a polarization multiplexed self-coherent signal by multiplexing a carrier in one polarization state with a data signal embodied in the sidebands that is in an orthogonal polarization state. FIG. 1 shows a simplified block diagram of one example of an OFDM transmission system that may be employed to transmit and receive such an OFDM signal.

The OFDM transmission system of FIG. 1 includes an OFDM transmitter 10 that transmits optical OFDM signals to an OFDM receiver 20 over an optical transmission medium 31 such as optical fiber. OFDM transmitter 10 includes an electrical processing unit 30 and an optical processing unit 40. OFDM transmitter 10 receives incoming serial data from a data source 15 so that it may first be electrically processed by an electrical processing unit 30. The electrical processing unit 30 includes an electrical modulator 32 that encodes the data in a suitable modulation format, the choice of which may depend on a variety of factors. The encoded data stream is converted from serial to parallel to provide the sub-channels and is directed to an inverse fast Fourier Transform (IFFT) module 34 to transform it from the frequency domain to the time domain. The resulting RF OFDM signal is then converted back to serial data and directed to a digital-to-analog converter (DAC) 35 for converting the digital data stream into an analog data stream. The electrical processing unit 30 then passes the analog data stream to the optical processing unit 40 for transforming the RF data stream into an optical OFDM signal. Optical processing unit 40 includes an optical modulator 42 that receives the RF OFDM signal and modulates it onto an optical carrier generated by a light source 44 (e.g., a laser). A polarization multiplexer 46 receives both the modulated optical carrier from the optical modulator and the unmodulated carrier from the light source 44 and multiplexes them in polarization states that are orthogonal to one another, thereby generating the polarization multiplexed self-coherent OFDM signal that is transmitted to the OFDM receiver 20 over the optical transmission medium 31.

The OFDM receiver 20 is essentially the inverse of the OFDM transmitter 10 and includes an electrical processing unit 60 and an optical processing unit 50. The optical processing unit 50 has an optical front-end 52 that receives the polarization multiplexed self-coherent OFDM signal and performs any optical processing that is needed before the signal is directed to an optical detector 54 such as a photodetector in order to transform the optical signal back to an RF signal. As will be described below, the optical front-end 52, in some implementations, may comprise various combinations of polarization analyzers, polarization beam splitters, optical couplers and optical splitters. The optical detector 54 then passes the RF OFDM signal to the electrical processing unit 60 in which the analog signal is first converted to a digital signal by analog-to-digital converter 62. The resulting digital signal undergoes serial to parallel conversion and is transformed from the time domain to the frequency domain by a fast Fourier Transform (FFT) module 64, after which it is again converted to a serial data stream. An electrical demodulator 66 then demodulates each sub-carrier separately from one another in the frequency domain to provide the output data to a desired destination 70.

At least some of the components in FIG. 1 may be implemented in software while other components may be implemented by configurable hardware or a mixture of software and configurable hardware. For instance, the FFT blocks and the IFFT blocks described in the present disclosure document may be implemented as configurable software algorithms. Furthermore, although the present disclosure is directed to an embodiment that implements the Fast Fourier Transform and the Inverse Fast Fourier Transform, this is by way of illustration only and should not be construed to limit the scope of the disclosure. It will be appreciated that in an alternate embodiment, for instance, the Fast Fourier Transform functions and the Inverse Fast Fourier Transform functions may be replaced by Discrete Fourier Transform (DFT) functions and Inverse Discrete Fourier Transform (IDFT) functions, respectively.

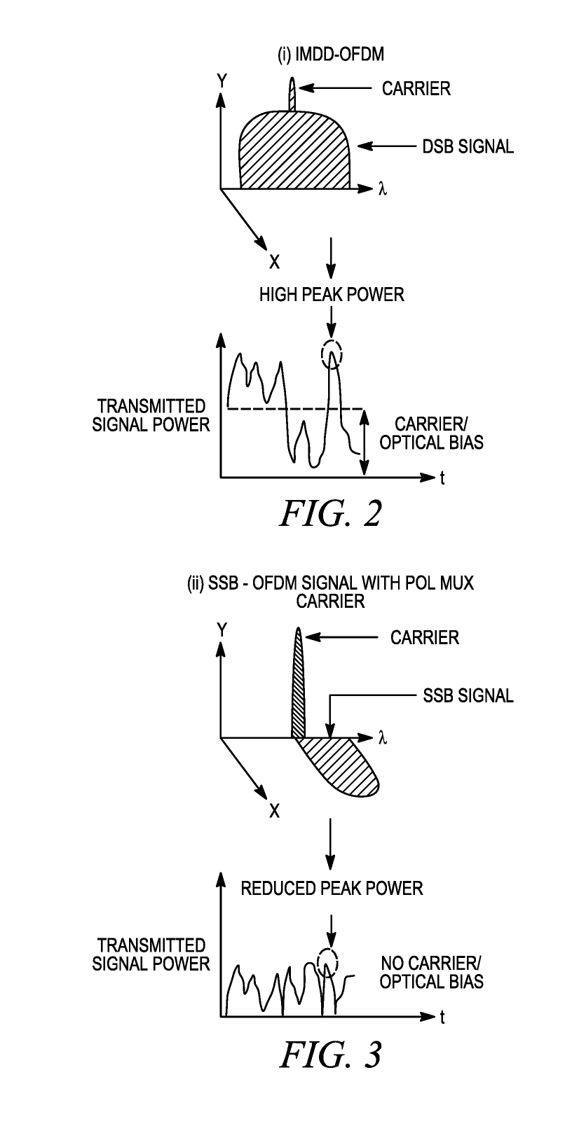

FIG. 2 shows a conventional intensity modulation and direct detection (IMDD) OFDM signal, which has a double sided signal spectrum around the optical carrier, with the signal and carrier residing in the same polarization plane. As also shown in the time domain, this translates to a carrier offset/bias that results in higher peak powers in the OFDM waveform. Since the double-sided IMDD-OFDM signal spectrum carries identical information in each sideband, a single sideband transmission is sufficient for information integrity. The two spectral sidebands around the optical carrier of a coherent OFDM signal can be independently turned on/off by configuring the lower and upper half of the OFDM subcarriers to produce a single sideband (SSB) OFDM signal.

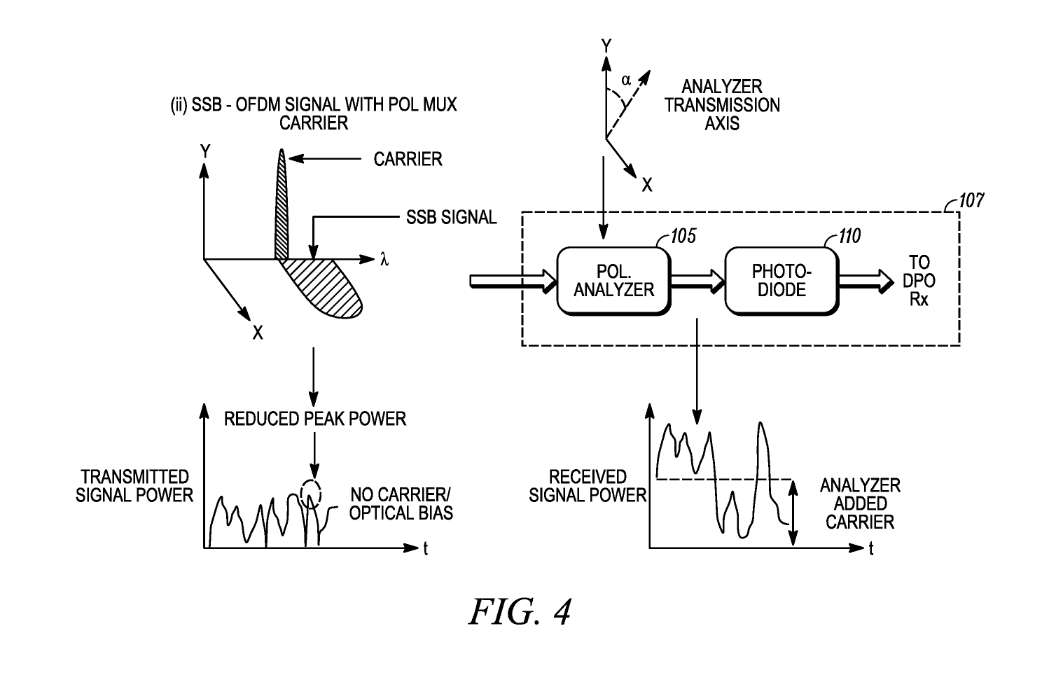

FIG. 3 shows a SSB OFDM signal in which the signal and carrier are transmitted in orthogonal polarization states in accordance with the present disclosure. The SSB OFDM is also shown in the time domain. By transmitting the signal and carrier with different polarizations, the carrier bias can be eliminated, thus reducing the peak optical power and the impact of fiber nonlinearities. This signal can be detected without the use of a coherent receiver. The presence of a carrier in the orthogonal polarization allows a direct detection receiver to be used. As shown in FIG. 4, the optical processing unit 107 of such a direct detection receiver (corresponding to e.g., optical processing unit 50 shown in FIG. 1) may employ a single polarization analyzer 105 followed by a single photodiode 110. The SSB OFDM in FIG. 4 is also shown in the time domain after traversing the polarization analyzer 105.

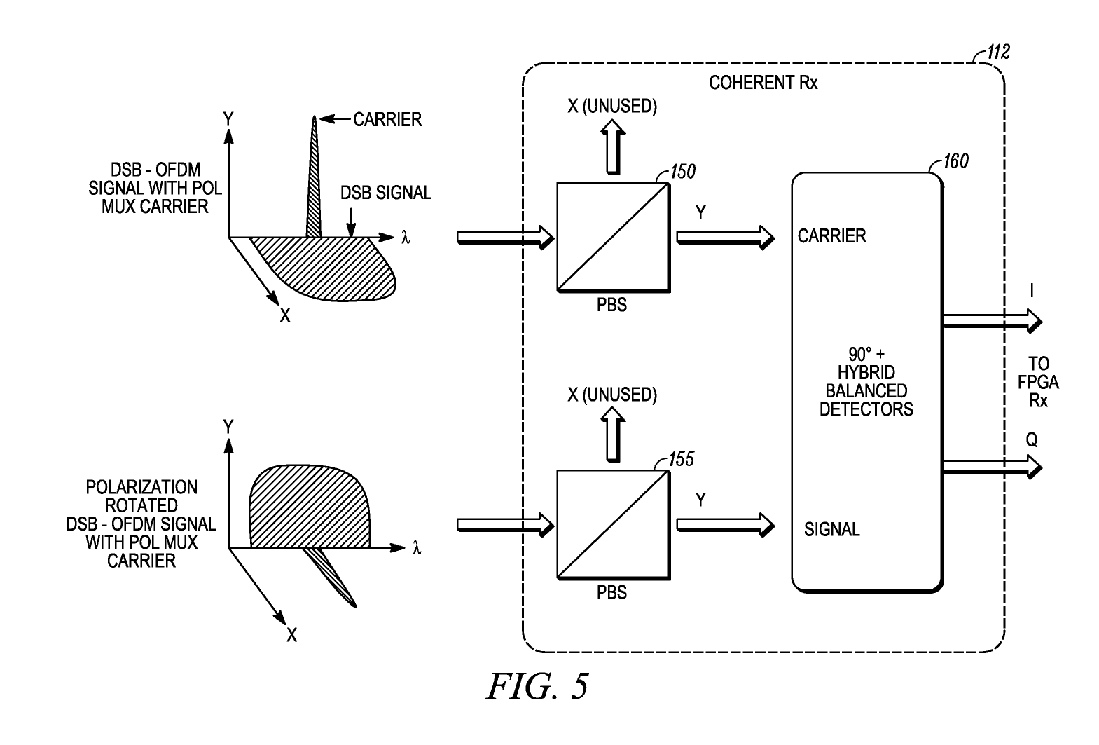

When a double sideband (DSB) OFDM signal is required, both the lower and upper halves of the subcarriers may be turned on. FIG. 5 shows a DSB OFDM signal in which the two sidebands are present in one polarization state and the carrier is present in the orthogonal polarization state. The signal is split into two components at the receiver. As shown, for one component the carrier is presented along the y-axis (i.e., in the Y-Polarization plane) and the signal is presented along the x-axis (i.e., in the X-Polarization plane). For the other component the carrier is presented along the x-axis and the signal is presented along the y-axis. A DSB OFDM signal requires a coherent receiver for detection. An example of an optical processing unit for such a coherent receiver is also shown in FIG. 5. The coherent receiver 112 includes first and second polarization beam splitters 150 and 155, which transmit the carrier component and the signal component, respectively, to a balanced detector 160. In this way the DSB-OFDM signal and the carrier are used for self-coherent detection.

Referring again to the optical processing unit 107 of the direct detection receiver shown in FIG. 4, the optimum value αₒₚₜ of the angle α between the transmission axis of the polarization analyzer 105 and the carrier polarization axis can be determined by considering the sum of the signal and carrier electric fields projected on the analyzer transmission axis and then squaring the sum. Since a photodiode functions as a square law detector, the detected electric field amplitudes can be expressed as:

$${[ {E}_{carr} \cdot {e}^{j \cdot {ω}_{carr} \cdot t} \cdot cos α + {E}_{sig} \cdot {e}^{j \cdot {ω}_{sig} \cdot t} \cdot sin α ]}^{2} = {E}_{carr}^{2} \cdot {cos}^{2} α + {E}_{sig}^{2} \cdot {sin}^{2} α + 2 \cdot {E}_{sig} \cdot {E}_{carr} \cdot cos [ ( {ω}_{carr} - {ω}_{sig} ) \cdot t ] \cdot cos α \cdot sin α \qquad ( 1 )$$

where E_{sig} and E_{carr} are the peak electric field amplitudes of the signal and carrier, respectively; ω_{carr} and ω_{sig} are the angular frequencies of the carrier and signal, respectively; and t is the time variable. The product S_{sig-carr}=2·E_{sig}·E_{carr}·cos [(ω_{carr}−ω_{sig})·t]·cos α·sin α contains the desired signal, while N_{sig-sig}=E_{sig}²·sin²α represents the noise term.

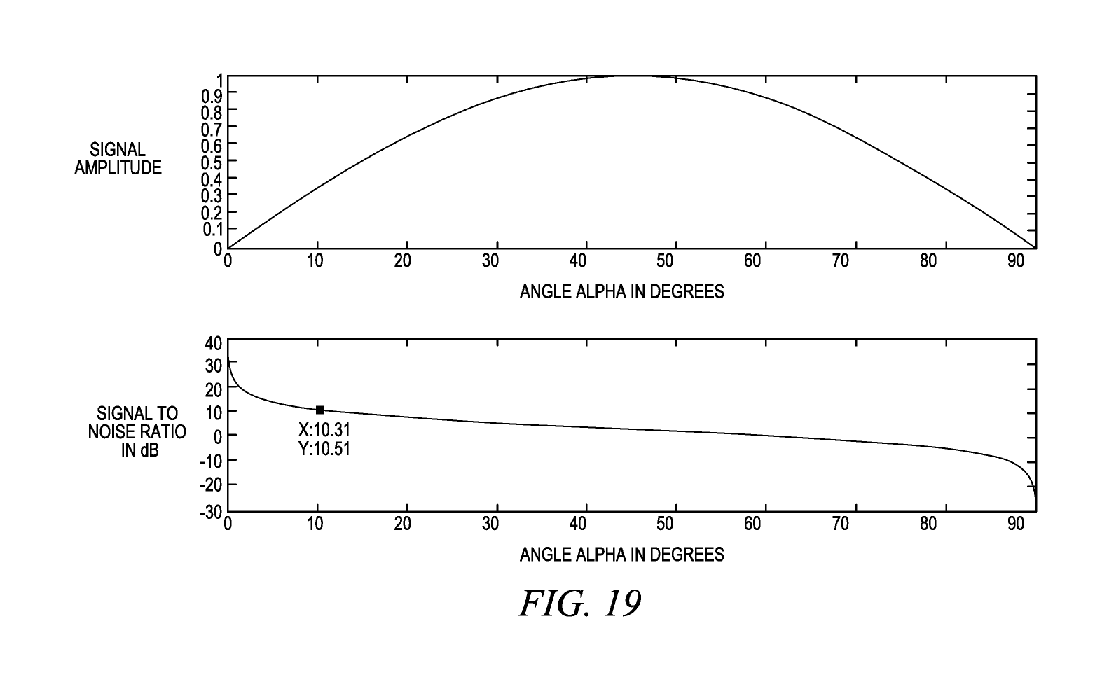

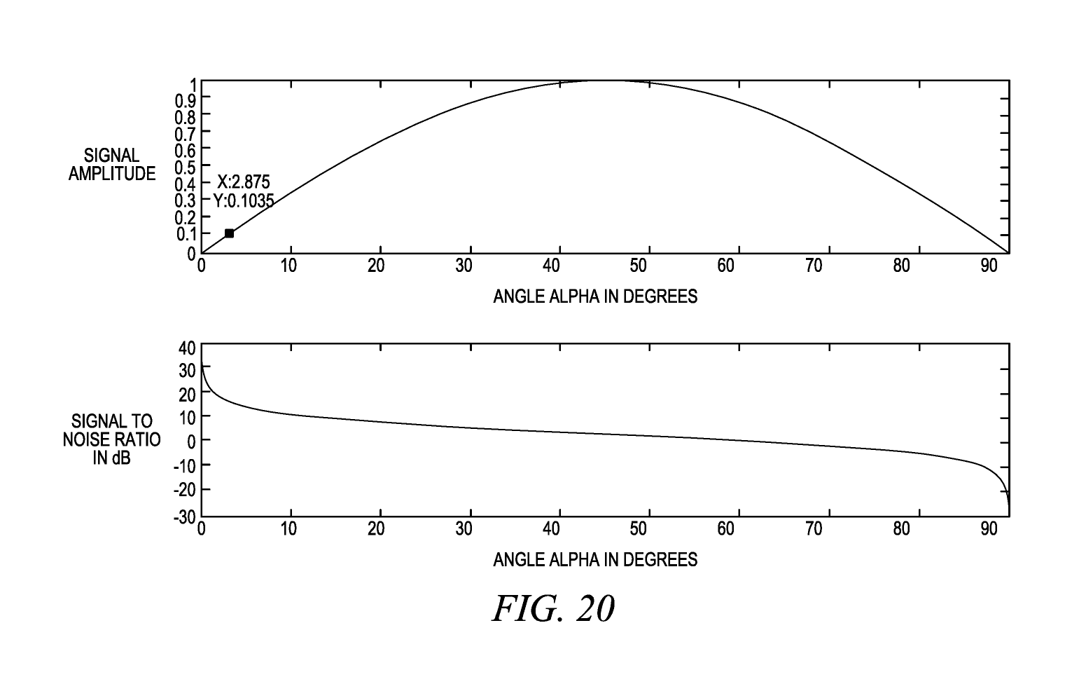

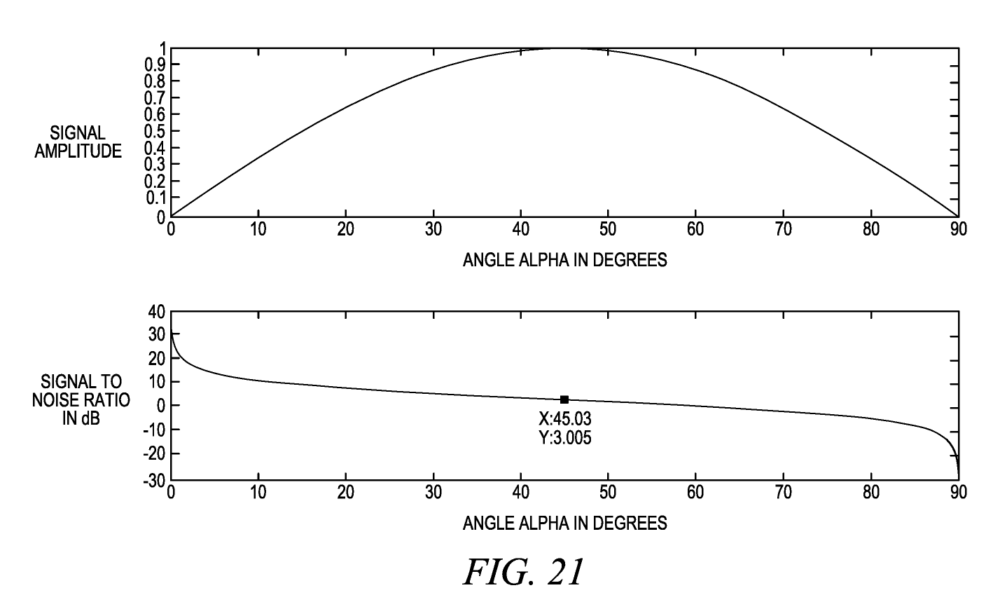

The upper graph in FIG. 19 shows, for one embodiment, the variation of the signal (the signal-carrier interference term i.e., the desired signal) with the analyzer angle alpha α. The lower graph shows the signal to noise ratio (SNR) variation with alpha. The upper graph in FIG. 20 shows that in this embodiment alpha should be at least 3° to achieve a signal amplitude that is at least 10% of the maximum signal value. Likewise, the lower graph in FIG. 21 shows that for this embodiment alpha should be at most 45° to achieve an SNR greater than 3 dB. Hence, FIGS. 20 and 21 together indicate that in one implementation the usable range for alpha may be advantageously chosen to be 3° to 45°.

The above calculation was for the unbalanced detection case. If dual analyzer balanced detection is considered, the noise term will be subtracted out and thus the SNR variation with alpha for each individual detection arm is not critical. However, in some implementations it nevertheless may be advisable not to exceed the 3-45 degree range for alpha as the subtraction in a balanced receiver is typically not ideal.

In one particular implementation, in order to ensure adequate reception quality, the signal-to-noise ratio S_{sig-carr}/N_{sig-sig} is specified to be greater than 10, while simultaneously maximizing S_{sig-carr}. Given this requirement, and assuming that E_{sig}=E_{carr}, it was found by numerical analysis that αₒₚₜ=10°.

### Experimental Demonstration

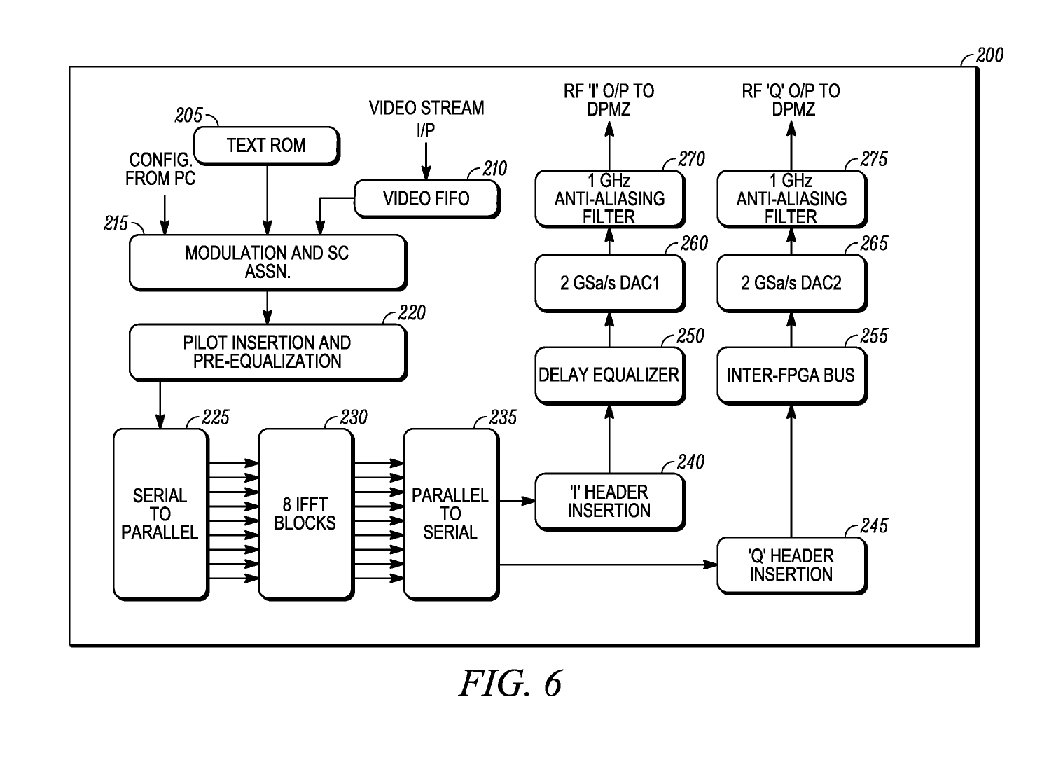

The arrangements shown in FIGS. 6-11 and described below are presented for purposes of experimentally demonstrating the techniques described above and are non-limiting illustrative examples of such arrangements. For instance, the systems and techniques described herein are not limited to the particular modulation formats used to modulate the subcarriers in the example shown below.

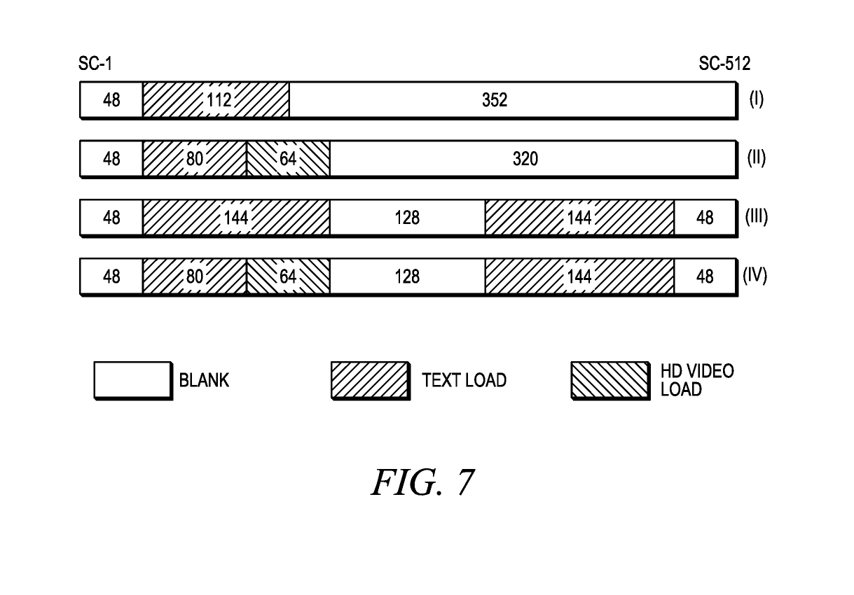

FIG. 6 shows the electrical or RF transmit path 200 of a coherent OFDM transmitter that was implemented on a field-programmable gate array (FPGA). In this example the input data includes both text 205 and video 210 in order to illustrate the system's ability to transmit both static and real-time dynamic traffic. The RF transmit path 200 includes a modulation module 215 that receives the raw data bits and modulates the data traffic onto a carrier and associates the data with the various subcarriers in accordance with one of the various schemes shown in FIG. 7(i)-7(iv). Pilot and pre-equalization module 220 inserts pilots into the signal and performs pre-equalization. The pilots are used by the receiver to compute the carrier phase offset. A serial-to-parallel converter 225 converts the signal onto eight parallel paths that are directed to eight parallel 512-point inverse fast Fourier transform (IFFT) hardware blocks 230, each clocked at 250 MHz, thereby producing a complex-valued OFDM signal with a maximum of 512 subcarriers. The subcarriers were turned on/off to produce either an SSB or a DSB OFDM signal and also to meet text and video traffic load in real time. After undergoing parallel-to-serial conversion in parallel-to-serial converter 235 to provide the in-phase (I) and quadrature (Q) OFDM channels, I and Q frame headers are inserted by I and Q frame insertion modules 240 and 245, respectively. The I channel then undergoes a delay in delay equalizer 250 to account for the path length differential that the I and Q channels undergo because of transmission along the inter-FPGA bus 255. In this way the two outputs respectively arrive at the two digital-to-analog converters (DACs) 260 and 265 at the same time. The DACs are clocked at 2 GSa/s to produce the in-phase (I) and the quadrature (Q) OFDM outputs. Finally, the I and Q OFDM outputs undergo filtering by anti-aliasing filters 270 and 275, respectively.

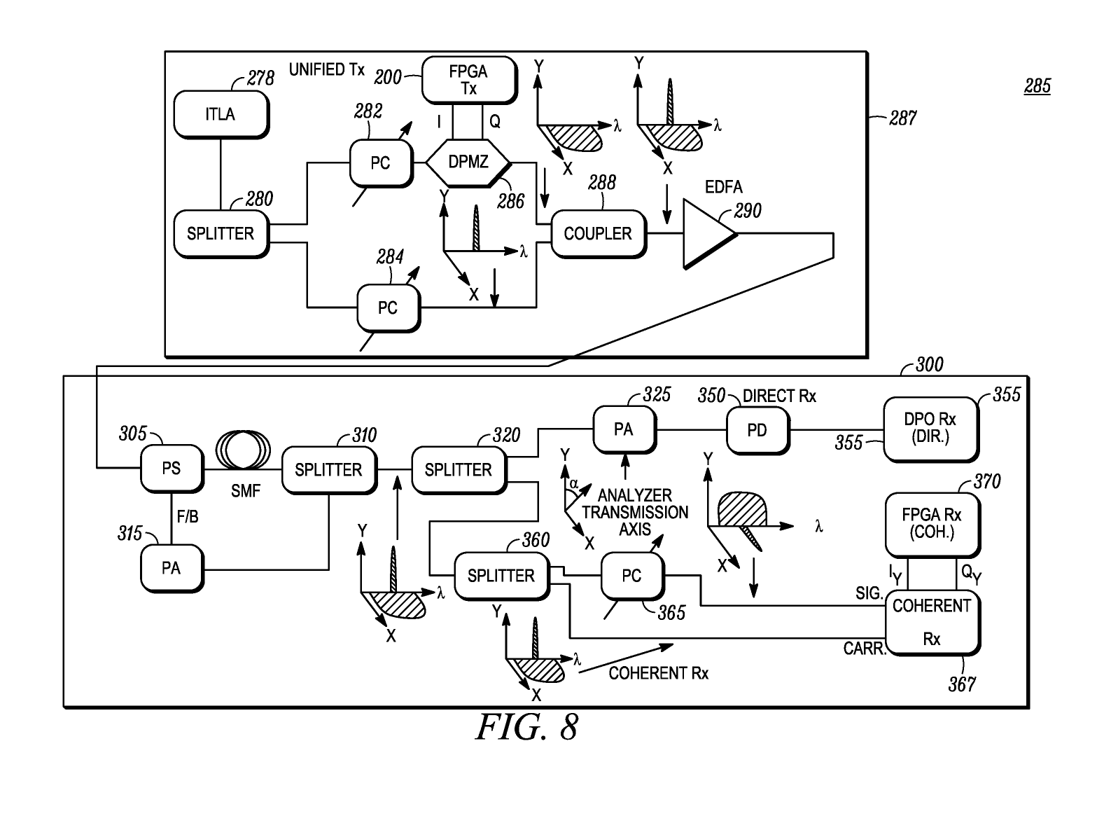

FIG. 8 shows a transmission system 285 that employs a coherent OFDM transmitter 287 that incorporates the RF transmit path 200 of FIG. 6. As shown, the RF OFDM signal generated by the transmit path 200 of the coherent OFDM transmitter of FIG. 6 is modulated onto an optical carrier generated by an integrable tunable laser assembly (ITLA) 278. The optical carrier is split by an optical splitter 280 that directs each portion to a respective polarization controller 282 and 284. The polarization controller 284 produces the unmodulated carrier in the Y-polarization plane at its output. The polarization controller 282 directs its output in the X-polarization plane to a dual-parallel Mach-Zehnder (DPMZ) modulator 286 with both I and Q arms biased at null. The DPMZ modulator 286 produces the modulated signal. The unmodulated carrier (at a wavelength of 1550.12 nm) is combined with the modulated signal in the orthogonal polarization state by an optical coupler 288 to produce the polarization multiplexed composite signal. The path length difference between the signal/DPMZ arm and the carrier arm is minimized to minimize the frequency offset between carrier and signal center frequencies before polarization multiplexing is performed. As further shown in FIG. 8, an erbium doped fiber amplifier (EDFA) 290 is used to launch the composite OFDM signal into the optical fiber transmission span at a specified power. An OFDM receiver 300 receives the composite OFDM signal transmitted by OFDM transmitter 287. The OFDM receiver 300 includes both a direct detection system and a coherent detection system to illustrate the relative ability of the techniques described herein to operate with both types of detectors. Of course, in a system deployed in the field generally only one type of detector system will be employed.

After traversing the optical transmission path, the composite OFDM signal is first directed to a polarization stabilization arrangement to compensate for random polarization drift that occurs in the optical fiber transmission span and maintain a constant polarization state. As shown in FIG. 8, the polarization stabilization arrangement includes polarization stabilizer 305, first optical splitter 310 and polarization analyzer 315. The optical splitter 310 directs a portion of the composite OFDM signal received from the polarization stabilizer 305 to the polarization analyzer 315, where it is used to generate a feedback control signal that the polarization analyzer 315 provides to the polarization stabilizer 305.

A second optical splitter 320 is used to split the composite OFDM signal so that one portion can be directed to the direct detection system and the other portion can be directed to the coherent detection system. Turning first to the direct detection system, the composite OFDM signal is provided by the second optical splitter 320 to a polarization analyzer 325 and a photodiode 350 similar to the direct detection system shown in FIG. 4. The transmission axis of the polarization analyzer 325 was set to an angle αₒₚₜ=10°, as explained above. The RF signal from the photodiode 350 was directed to a digital phosphor oscilloscope (DPO) 355 with a sampling rate of 25 GSa/s. An OFDM receiver was implemented in MATLAB running on the DPO 355, with the 25 GSa/s DPO waveform being decimated to 2 GSa/s before OFDM processing began. The direct detector system did not process video data as it samples only 80 μs segments of the received OFDM waveform, about once every second and hence lacks the necessary throughput.

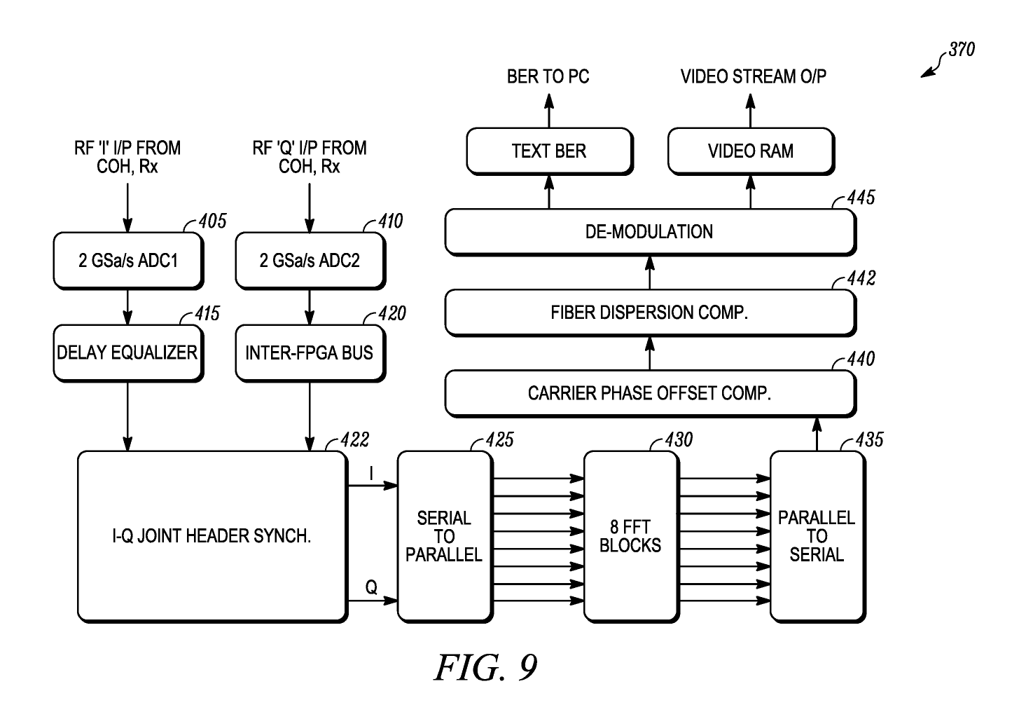

Turning next to the coherent detection system in FIG. 8, which is capable of handling polarization multiplexed inputs, the second optical splitter 320 directs the composite OFDM signal to a third optical splitter 360, which in turn directs one portion of the composite OFDM signal to a polarization controller 365 for rotating the polarization state of the SSB or DSB signal. The polarization controller 365 directs the SSB or DSB signal to coherent receiver 367. The third optical splitter 360 directs the other portion of the composite OFDM signal directly to the coherent receiver 367. The I and Q RF outputs of the coherent receiver 367 are connected to the two GSa/s analog-to-digital converter (ADC) inputs of a receiver FPGA system 370, which is shown in more detail in FIG. 9.

The receiver FPGA system 370 is the functional inverse of the OFDM transmitter and, as shown in FIG. 9, includes the two ADCs 405 and 410 that respectively receive the I and Q RF outputs and delay equalizer 415 for compensating for the path length differential because of transmission along the inter-FPGA bus 420. The I and Q RF outputs are then directed to an I-Q joint header synchronization module 422 to extract the header information, after which the outputs undergo serial to parallel conversion in serial to parallel converter 425 before being directed to eight parallel 512-point fast Fourier transform (FFT) blocks 430. The transformed data then undergoes parallel to serial conversion in parallel to serial converter 435 and carrier phase offset compensation in carrier phase offset compensator 440. Real-time fiber dispersion compensation is then performed by dispersion compensator 442 before demodulating the signal to extract the data in demodulation module 445. The FPGA based coherent receiver 370 is able to process video data as it continuously samples the received OFDM waveform and has the necessary throughput.

The transmission system shown in FIG. 8 was operated by varying the OFDM signal bandwidth at the transmitter to produce SSB or DSB OFDM signals. The direct receiver system was able to successfully demodulate all SSB-OFDM signals, while the coherent receiver system was able to demodulate both SSB and DSB OFDM signals. The quality of the video received by the FPGA receiver was excellent in all OFDM configurations. The bit rate of the system varied and was: 414.9 Mb/s for the configuration in FIG. 7(i), with subcarriers carrying text using BPSK modulation; 829.9 Mb/s for the configuration in FIG. 7(ii), with subcarriers carrying text using QPSK modulation and subcarriers carrying video using BPSK modulation; 2.13 Gb/s for the configuration in FIG. 7(iii), with subcarriers carrying text using QPSK modulation.

Comparison of Polarization Multiplexed SSB-OFDM with IMDD-OFDM

Using the same photodiode and DPO for direct detection, the advantages of the polarization multiplexed SSB-OFDM scheme described herein over the IMDD-OFDM scheme can be quantified. The OFDM transmitter was set to produce either a polarization multiplexed SSB signal or an IMDD signal that was launched into the fiber at identical optical powers. The polarization multiplexed SSB signal-to-carrier ratio was kept identical to its IMDD equivalent. The modulation format on all OFDM subcarriers carrying text data was either BPSK or QPSK, while video data was not transmitted.

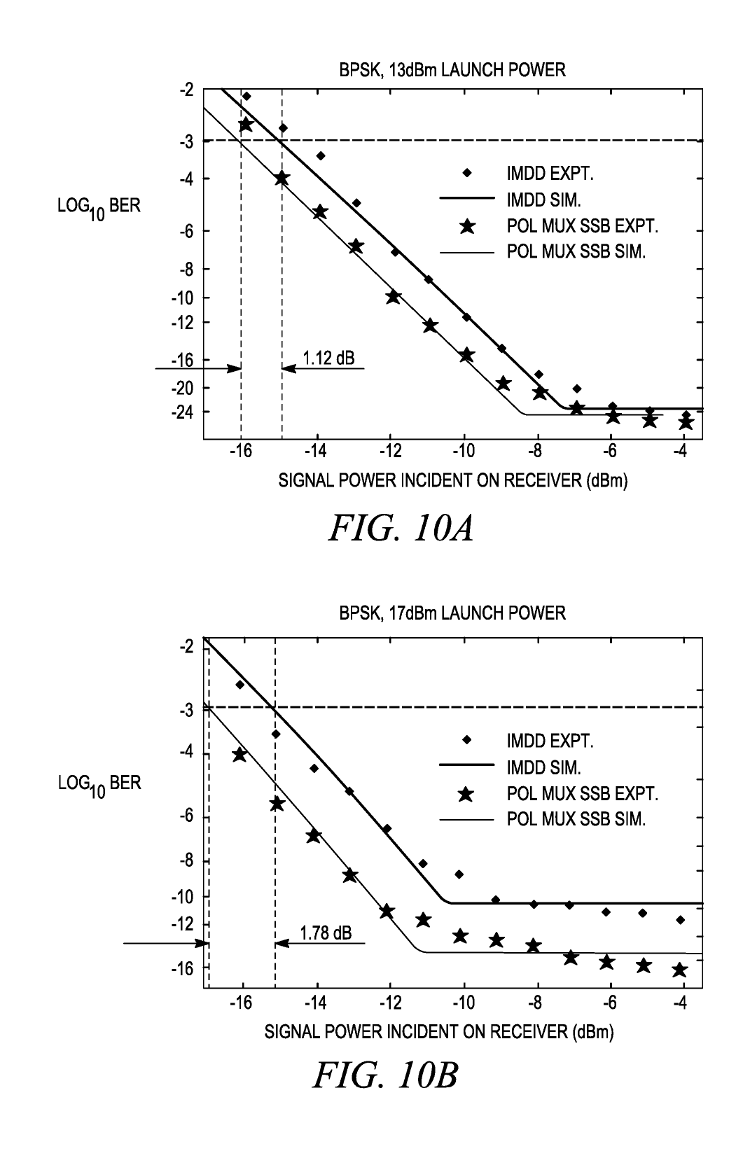

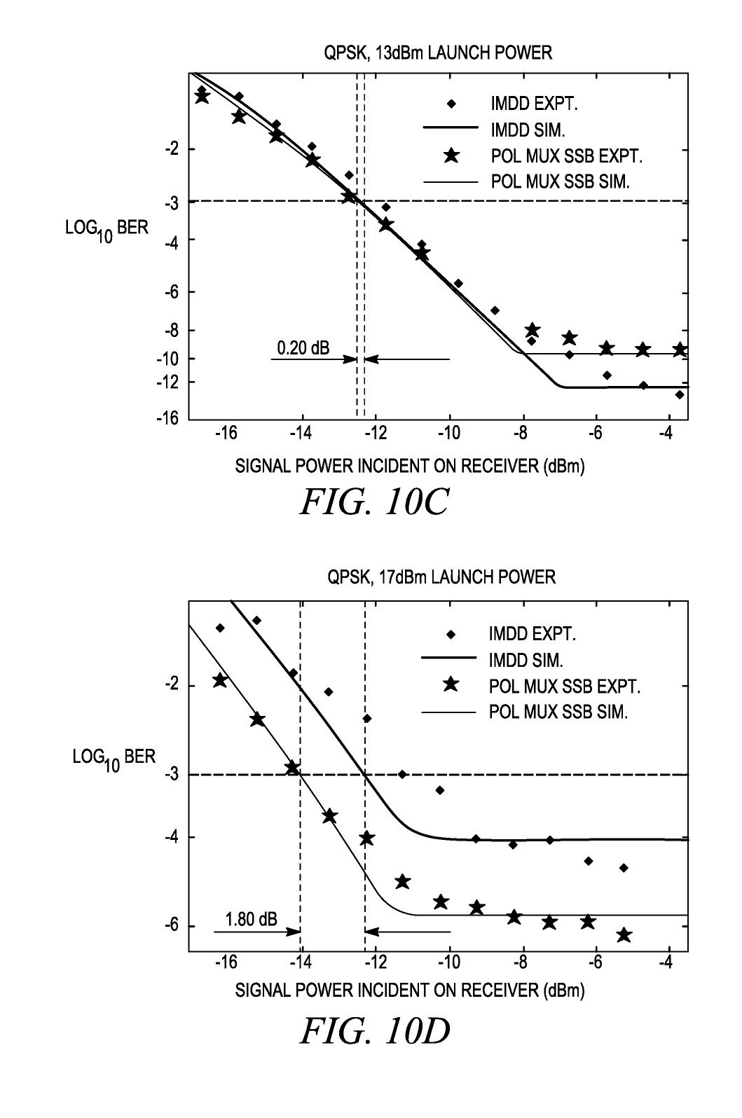

FIGS. 10(a), (b), (c) and (d) show the bit error rate (BER) performance of the polarization-multiplexed SSB-OFDM scheme versus the IMDD-OFDM scheme for BPSK and QPSK modulation formats at 13 dBm and 17 dBm launch powers into the fiber. The X axis in plots (a)-(d) indicates the optical power of the signal alone with no carrier offset, which enables a meaningful comparison between IMDD and SSB OFDM waveforms which have different carrier offsets. Dashed vertical lines indicate the receiver sensitivity at 1×10⁻³ BER.

At lower launch power (13 dBm), the IMDD-OFDM signal had an equivalent or slightly better BER values as compared to the polarization multiplexed SSB-OFDM (see FIGS. 10(a) and 10(c)). At higher launch powers (17 dBm), the polarization multiplexed SSB-OFDM has a lower BER and higher receiver sensitivity (see FIGS. 10(b) and 10(d)), which demonstrates the resilience of the polarization multiplexed transmission scheme to impairments due to nonlinear effects in fiber. The simulation curves match well with the experiment data.

In the experiment, a non-Hermitian symmetric input was used (one half of the subcarriers were turned off as shown in FIG. 7(i) and FIG. 7(ii)) to the IFFT block at the FPGA transmitter. The I output was used alone to produce the IMDD-OFDM. Using numerical simulation, this scheme was compared with a Hermitian symmetric IMDD-OFDM scheme.

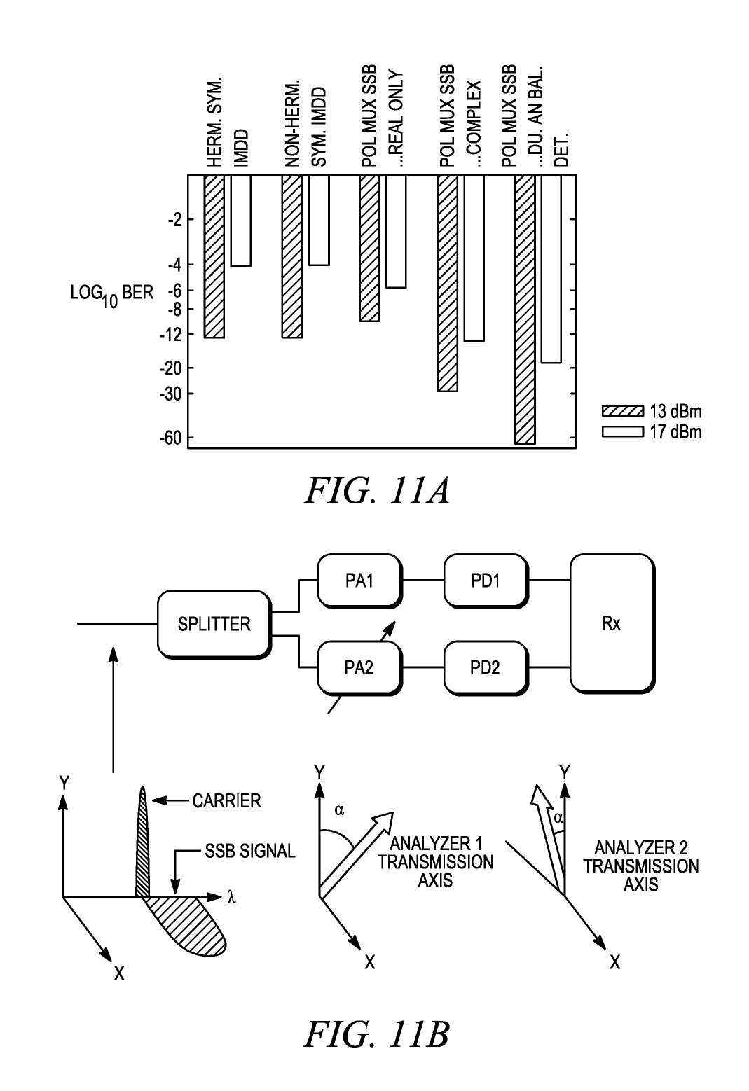

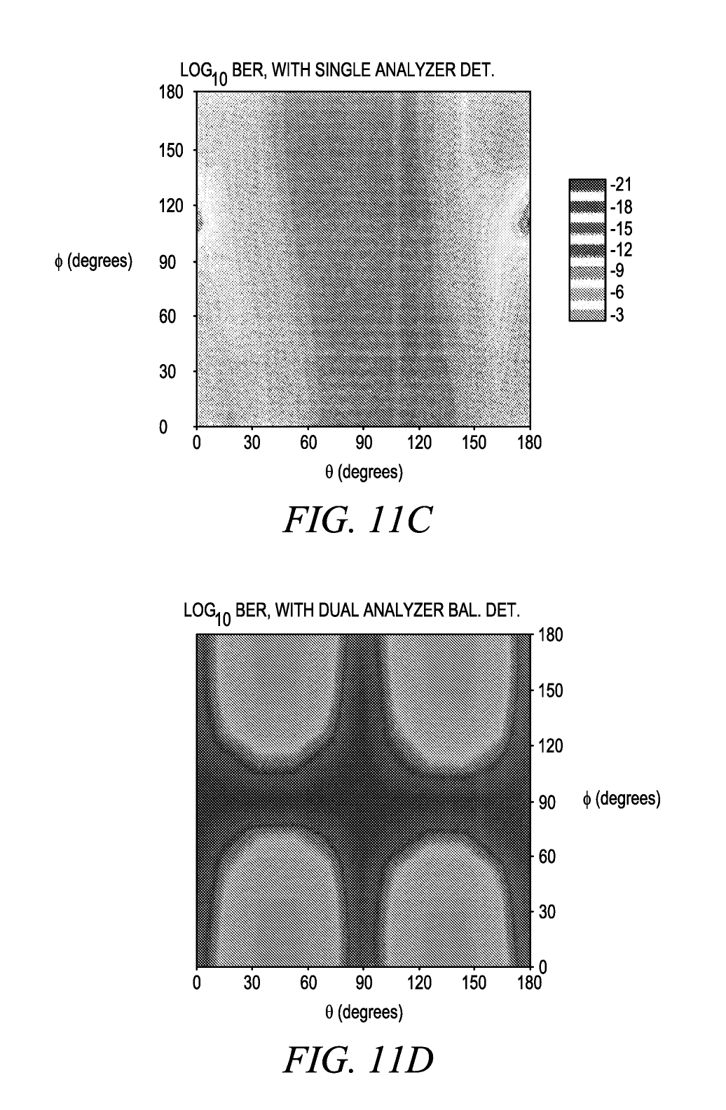

FIG. 11(a) shows the BER performance of the Hermitian symmetric IMDD-OFDM scheme versus the non-Hermitian symmetric IMDD-OFDM scheme (bar groups 1 and 2), using only the real output at the receiver versus using the complex output at the receiver (bar groups 3 and 4), dual analyzer balanced detection (bar group 5). FIG. 11(b) shows the dual analyzer balanced detection arrangement that was used to obtain the results in FIG. 11(a). FIGS. 11(c) and 11(d) show the BER performance across various polarization states of the received light for polarization-multiplexed SSB-OFDM, QPSK subcarrier modulation, 17 dBm launch power, α=αₒₚₜ=10° in single analyzer detection (FIG. 11(c)), and in dual analyzer balanced detection (FIG. 11(d)).

The BER levels of the two schemes are identical at both 13 dBm and 17 dBm launch powers (see FIG. 11(a), bar groups 1 and 2). Therefore, using just the I output of the non-Hermitian symmetric IFFT incurs no additional penalty. Simulation also reveals that there is a performance penalty for using only the real output at the receiver, as is done at the SSB-OFDM direct receiver in the experiment, when compared to using the complex output at the receiver (see FIG. 11(a), bar groups 3 and 4). However, using a dual analyzer balanced detection scheme (see FIG. 11(a), bar group 5), described in the next section, produces a BER performance superior to the scheme using the complex output at the receiver.

### An Enhanced Detection Scheme: Dual Analyzer Balanced Detection

In general, coherent receivers use balanced photodiode pairs that enable the signal-signal interference term to be cancelled out. In the direct detection scheme discussed above, a single photodiode is used and the analyzer transmission axis is set at an optimal angle αₒₚₜ to minimize the signal-signal interference term. However, by using a second analyzer and photodiode pair with its analyzer transmission axis set to an identical angle, but with an opposite rotation, as shown in FIG. 11(b), the two receivers perform like a regular balanced photodiode pair. Based on Eqn. (1) and by considering a negative analyzer angle, the output from the second arm now takes the form

$${[ {E}_{carr} \cdot {e}^{j \cdot ( {ω}_{carr} \cdot t + δ )} \cdot cos ( - α ) + {E}_{sig} \cdot {e}^{j \cdot ( {ω}_{sig} \cdot t + δ )} \cdot sin ( - α ) ]}^{2} = {[ {E}_{carr} \cdot {e}^{j \cdot ( {ω}_{carr} \cdot t + δ )} \cdot cos α - {E}_{sig} \cdot {e}^{j \cdot ( {ω}_{sig} \cdot t + δ )} \cdot sin α ]}^{2} = {E}_{carr}^{2} \cdot {cos}^{2} α + {E}_{sig}^{2} \cdot {sin}^{2} α - 2 \cdot {E}_{sig} \cdot {E}_{carr} \cdot cos ( ( {ω}_{carr} - {ω}_{sig} ) \cdot t + ( δ - δ ) ) \cdot cos α \cdot sin α = {E}_{carr}^{2} \cdot {cos}^{2} α + {E}_{sig}^{2} \cdot {sin}^{2} α - 2 \cdot {E}_{sig} \cdot {E}_{carr} \cdot cos ( ( {ω}_{carr} - {ω}_{sig} ) \cdot t ) \cdot cos α \cdot sin α \qquad ( 2 )$$

Any residual phase δ in the second arm is identical for both signal and carrier as they co-propagate in the same optical path and hence δ cancels out in the signal-carrier interference term. The negative analyzer angle in the second arm has the effect of giving the signal-carrier interference term a negative sign. Thus, the electrical outputs of the two arms given by Eqns. (1) and (2) when subtracted leave behind only the signal-carrier interference term. In addition to being able to eliminate the signal-signal interference term, the dual analyzer balanced detection (DABD) scheme is also resilient to the polarization drift occurring in the transmission fiber. In simulation, the polarization state at the transmission fiber output was varied by varying θ−the orientation angle of the polarization ellipse and ϕ—the phase difference between the orthogonal decompositions of polarization (see FIG. 11). The BER performance with the DABD scheme (see FIG. 11(d)) is superior when compared to single analyzer detection (see FIG. 11(c)). Specifically, a larger area in FIG. 11(d) has a lower BER as compared to FIG. 11(c), which allows the polarization stabilizer to have a wider range of target polarization states.

### Additional Receiver Examples

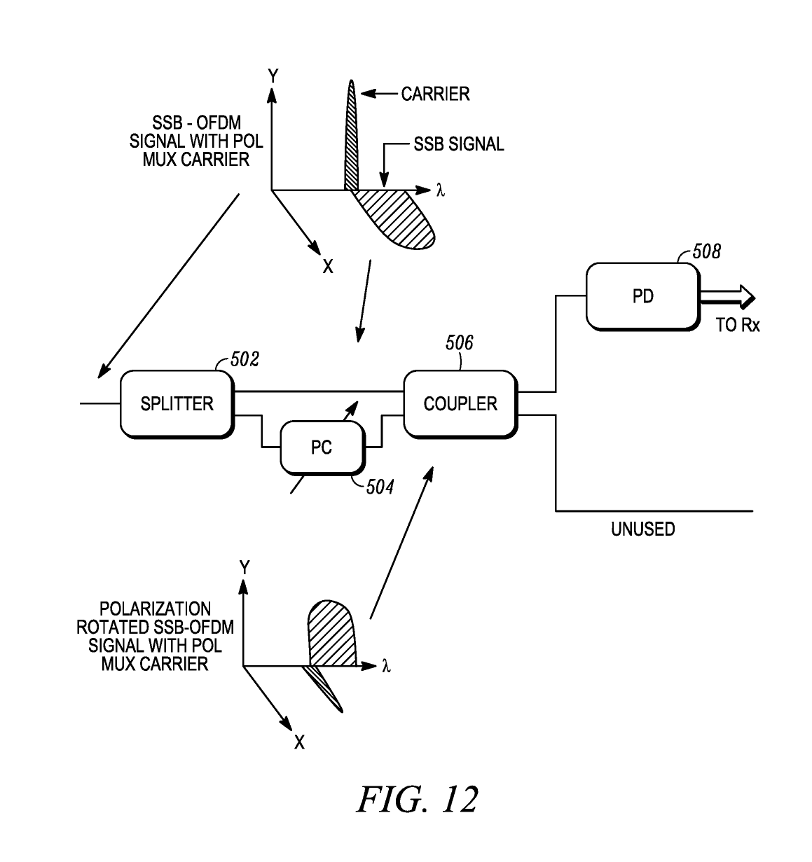

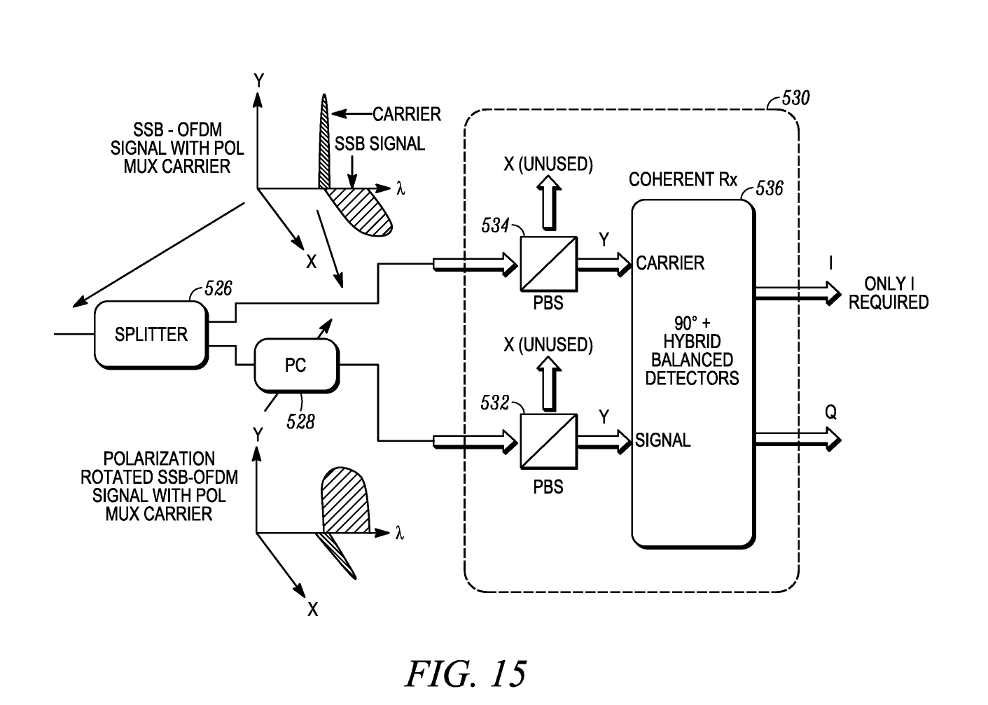

FIG. 4, described above, shows a direct detection, unbalanced receiver that includes a single polarization analyzer followed by a single photodetector such as a photodiode. FIGS. 12-18 show additional examples of direct detection receivers that may be used as a receiver for receiving a self-coherent optical signal such as shown in FIG. 4, which has an optical carrier frequency in one polarization state and a single sideband in a second polarization state orthogonal to the first polarization state. FIGS. 12-14 show unbalanced receivers that include a single photodetector and FIGS. 15-18 show balanced receivers that include a pair of photodetectors.

FIG. 12 shows an example of an optical processing unit for an unbalanced receiver that includes a splitter 502, polarization controller (PC) 504, a coupler 506 and a photodiode 508. The PC 504 rotates the polarization state in one arm of the splitter-coupler pair so as to enable the signal and carrier to be present in the same polarization plane and thus interfere.

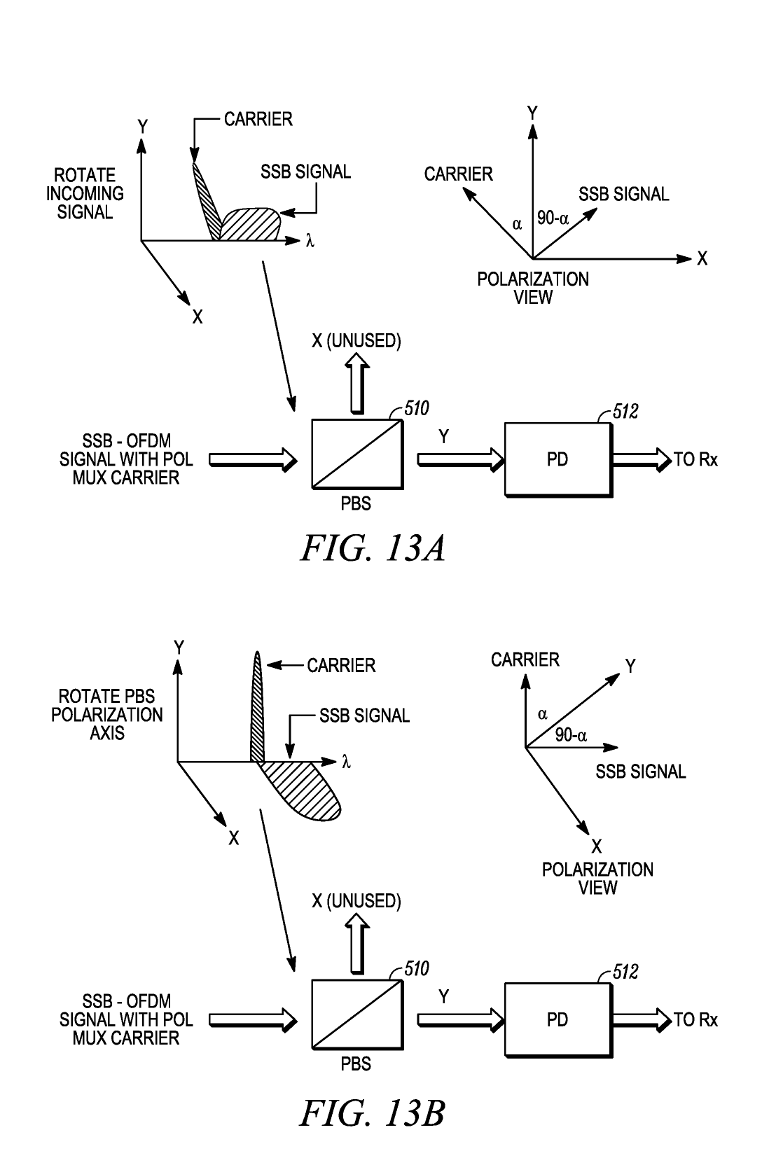

FIGS. 13a and 13b show another example of an optical processing unit for an unbalanced receiver that includes a polarization beam splitter (PBS) 510 and a photodetector 512. In FIG. 13a the incoming light has its polarization state rotated and in FIG. 13b the PBS polarization axes are rotated. The angle α between the carrier and the y-axis can be set to 45° or α=αₒₚₜ, for example.

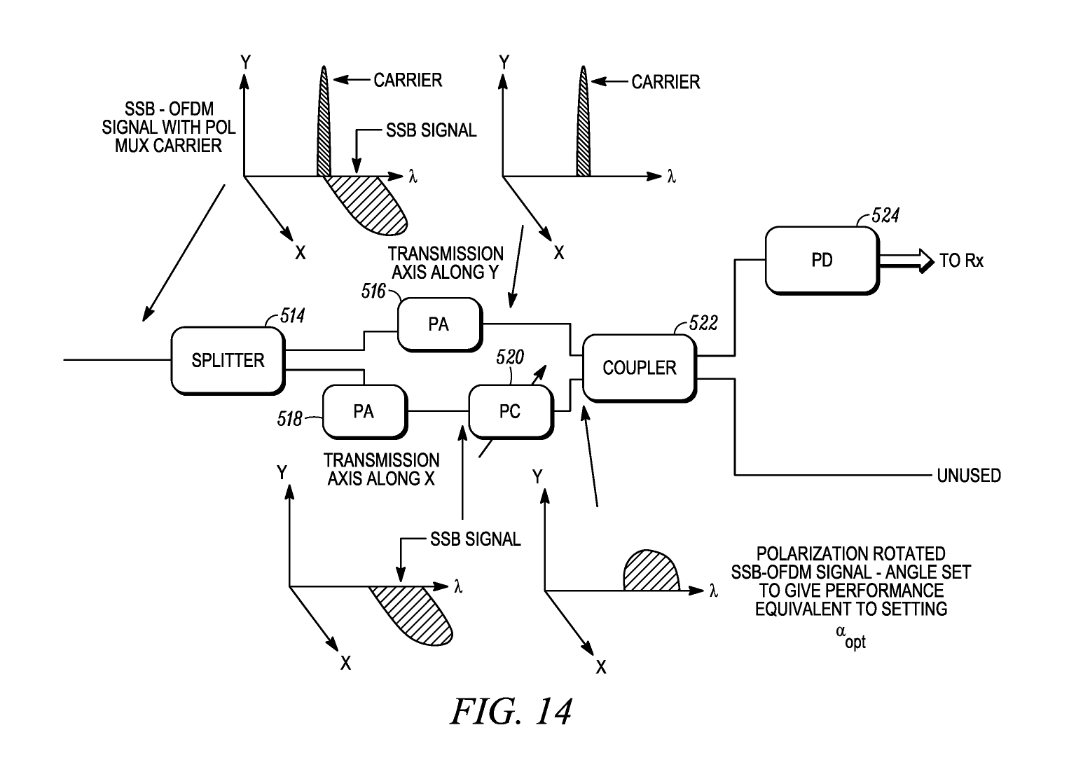

FIG. 14 show another example of an optical processing unit for an unbalanced receiver that includes an optical splitter 514, two polarization analyzers (PA) 516 and 518 each coupled to an output of the optical splitter 514, a polarization controller (PC) 520 following one of the polarization analyzers 518, a coupler 522 for recombining the signals and a photodiode 524 receiving the signal from the coupler. The polarization analyzers eliminate one polarization component in each arm. The polarization controller 520 rotates the polarization state in one arm of the splitter-coupler pair so as to enable the signal to have a component along the Y polarization plane and thus interfere with the carrier.

FIG. 15 shows an example of an optical processing unit for a balanced receiver that includes a splitter 526, polarization controller (PC) 528 located in one arm and a coherent receiver 530 capable of handling polarization multiplexed inputs. The PC 528 rotates the polarization state in one arm of the splitter output so as to enable the signal and carrier to be present in the same polarization plane (the Y polarization plane in this case) and thus interfere. Polarization beam splitters (PBSs) 532 and 534 direct the signals to the coherent receiver 530. Balanced photodiodes 536 are present in the coherent receiver 530 and, since the signal is a single sideband (SSB), signal, only the I output of the coherent receiver is required.

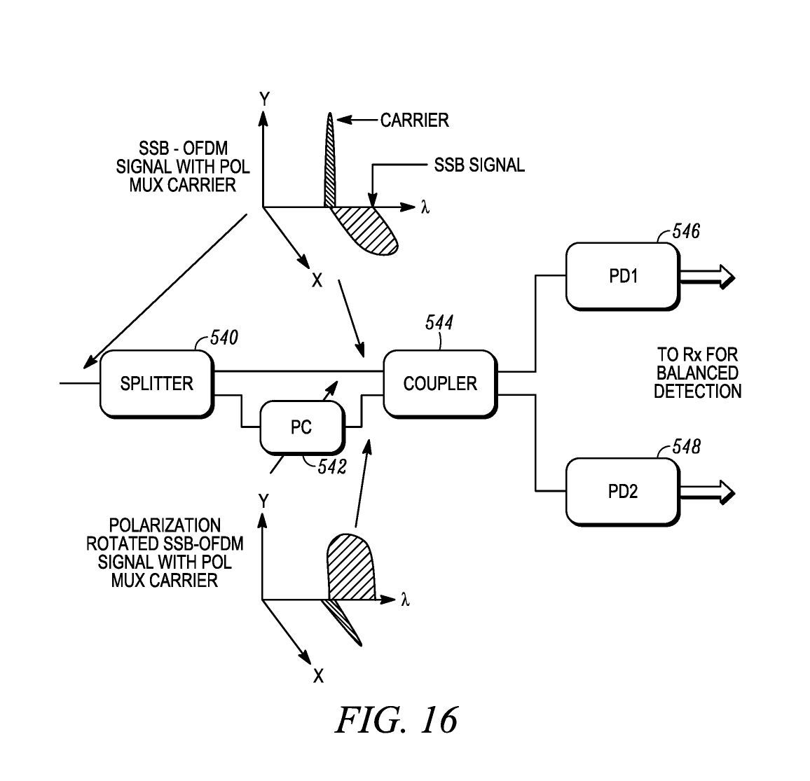

FIG. 16 shows another example of an optical processing unit for a balanced receiver that includes a splitter 540, polarization controller (PC) 542 located in one arm and a 2×2 coupler 544 that recombines the signal from each arm and directs portions of the resulting signal to a pair of photodiodes 546 and 548. The PC 542 rotates the polarization state in one arm of the splitter-coupler pair so as to enable the signal and carrier to be present in the same polarization plane and thus interfere.

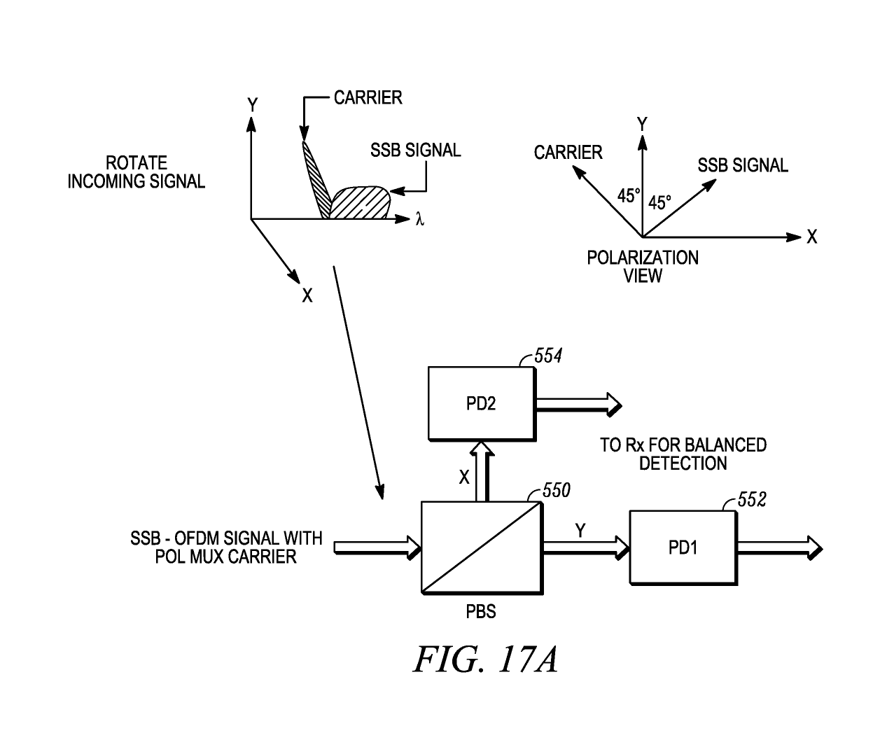

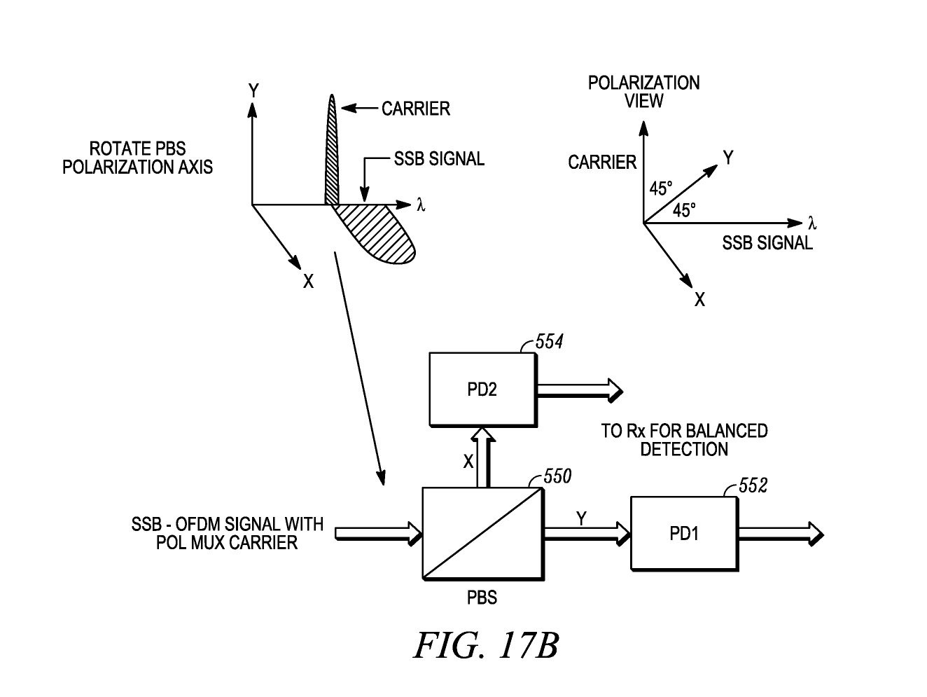

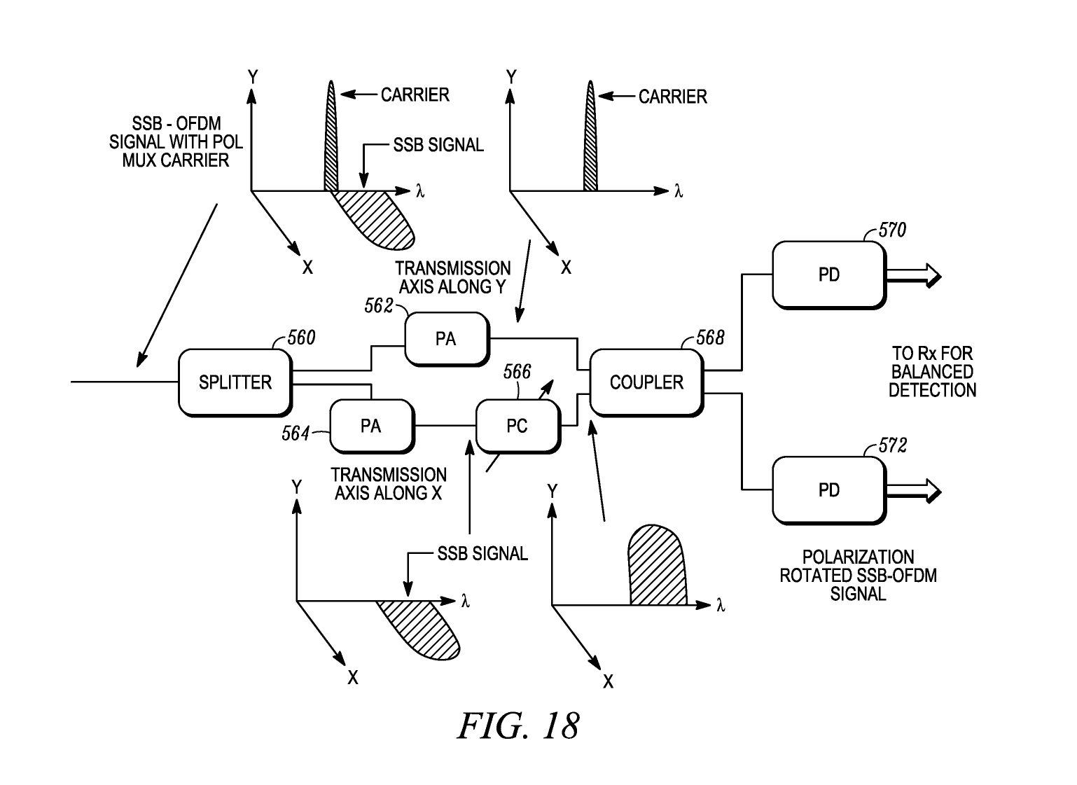

FIGS. 17a and 17b show another example of an optical processing unit for a balanced receiver that includes a polarization beam splitter (PBS) 550 and two photodiodes 552 and 554 each receiving a portion of the composite OFDM signal located in a different one of the polarization planes. In FIG. 17a the incoming composite OFDM signal has its polarization state angled at 45° with respect to the PBS polarization axes while in FIG. 17b the polarization components of the composite OFDM signal are respectively located in the X and Y polarization planes and the polarization axes of the PBS are rotated by 45°.

FIG. 18 shows another example of an optical processing unit for a balanced receiver that includes a splitter 560, two polarization analyzers (PAs) 562 and 564 each located in one output arm of the splitter 560, a polarization controller (PC) 566 that receives the signal from one of the PAs, and a 2×2 coupler 568 that recombines the signals received from the PA 562 and PC 566 and directs a portion of the combined signal to each of two photodiodes 570 and 572. The PAs 562 and 564 eliminate one polarization component in each arm. The PC 566 rotates the polarization state in one arm of the splitter-coupler pair so as to enable the signal to be directed along the Y polarization plane and thus interfere with the carrier.

In summary, the resilience of the polarization-multiplexed direct detection scheme to fiber nonlinearities has been experimentally verified and receiver sensitivity improvements of up to 1.8 dB have been achieved compared to the IMDD-OFDM scheme. The effectiveness of the dual analyzer balanced detection scheme in providing better BER performance even with a minor drift in the polarization state of the received light has also been experimentally verified.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

In addition, it should be understood that the figures, which highlight the functionality and advantages of the present invention, are presented for illustrative purposes only. The architecture of the example aspect of the present invention is sufficiently flexible and configurable, such that it may be utilized (and navigated) in ways other than that shown in the accompanying figures.

Although example aspects herein have been described in certain specific example embodiments, many additional modifications and variations would be apparent to those skilled in the art. It is therefore to be understood that the various example embodiments herein may be practiced otherwise than as specifically described. Thus, the present example embodiments, again, should be considered in all respects as illustrative and not restrictive.

1. A method of detecting an optical signal, comprising:
receiving a self-coherent optical signal having an optical carrier frequency in a first polarization state and a single sideband in a second polarization state orthogonal to the first polarization state; and
detecting a polarization component of both the optical carrier frequency and the single sideband.

2. The method of claim 1, wherein detecting the polarization components of both the optical carrier frequency and the single sideband comprises detecting the polarization components of both the optical carrier frequency and the single sideband using an unbalanced receiver having a single photodetector.

3. The method of claim 2, further comprising using a polarization analyzer to select the polarization components of both the optical carrier frequency and the single sideband prior to detecting the polarization components.

4. The method of claim 3, wherein the polarization analyzer has a transmission axis forming a prescribed transmission angle with respect to a polarization axis parallel to the first polarization state.

5. The method of claim 4, wherein the prescribed transmission angle is between 3 and 45 degrees.

6. The method of claim 5, wherein the prescribed transmission angle is about 10°.

7. The method of claim 1, wherein receiving the optical signal includes receiving the optical signal with a polarization beam splitter having a polarization axis oriented at a positive prescribed angle with respect to the first polarization state and at a negative prescribed angle with respect to the second polarization state, the positive and negative prescribed angles being equal in magnitude.

8. The method of claim 1, wherein the optical signal is an OFDM optical signal in which the single sideband includes a plurality of subcarriers.

9. The method of claim 8, wherein at least one of the subcarriers is modulated with data using a modulation format selecting from the group consisting of BPSK modulation and QPSK modulation.

10. The method of claim 1, wherein detecting the polarization components of both the optical carrier frequency and the single sideband comprises detecting the polarization components of both the optical carrier frequency and the single sideband using a balanced receiver having a pair of photodetectors.

11. The method of claim 10, further comprising:
splitting the optical signal into first and second portions;
for each of the first and second portions, selecting the polarization components of both the optical carrier frequency and the single sideband, the selected polarization components of the first portion being in a polarization plane that defines a positive prescribed angle with the respect to a plane defined by the first polarization state and the selected polarization components of the second portion being in a polarization plane that defines a negative prescribed angle with the respect to a plane defined by the first polarization, the positive and negative prescribed angles being equal in magnitude; and
detecting the selected polarization components of the first and second portions of the optical signal.

12. The method of claim 10, wherein receiving the optical signal includes receiving the optical signal with a polarization beam splitter (PBS) having a polarization axis oriented at 45° with respect to the first and second polarization states and further comprising directing a first optical output signal from the PBS to a first of the photodetectors and a second optical output signal from the PBS to a second of the photodetectors.

13. The method of claim 2, wherein receiving the optical signal includes receiving the optical signal with a polarization beam splitter (PBS) having a polarization axis oriented at a first angle α with respect to the first polarization state and at a second angle (90°−α) with respect to the second polarization state and further comprising directing an optical output signal from the PBS to the single photodetector.

14. The method of claim 11, wherein selecting the polarization components of the first and second portions of the optical signal is performed using first and second polarization analyzers, respectively.

15. The method of claim 10, further comprising:
splitting the optical signal into first and second portions;
selecting the first polarization state from the first portion of the optical signal and selecting the second polarization state from the second portion of the optical signal;
rotating the second polarization state of the second portion of the optical signal into the first polarization state to define a rotated second portion of the optical signal; and
coupling the selected first polarization state from the first portion of the optical signal and the rotated second portion of the optical signal and directing a first output signal from the coupler to a first photodetector and directing a second output signal from the coupler to a second photodetector.

16. The method of claim 10, further comprising:
splitting the optical signal into first and second portions;
rotating the polarization of the first or second portions so that the first and second polarization states are rotated into the second and first polarization states, respectively; and
coupling the rotated first or second portion of the optical signal and the other of the first or second portion of the optical signal and directing a first output signal from the coupler to a first photodetector and directing a second output signal from the coupler to a second photodetector.

17. The method of claim 10, further comprising:
splitting the optical signal into first and second portions;
rotating the polarization of the second portion of the optical signal such that the first and second polarization states are rotated into the second and first polarization states, respectively;
directing the first portion of the optical signal to a first PBS and the rotated second portion of the optical signal to a second PBS; and
directing an output from the first PBS and an output from the second PBS that is in a common polarization state with the output from the first PBS to first and second photodetectors, respectively.
